(19) United States
(12) Patent Application Publication
(10) Pub. No.: US 2026/0269205 A1
(43) Pub. Date: Sep. 10, 2026

(54) Apparatus for generating ions

(71) Applicants: Thermo Fisher Scientific (Bremen) GmbH, Bremen (DE); Thermo Fisher Scientific Brno s. r. o., Brno (CZ)

(72) Inventors: Ralf Günter Hartmer, Hamburg (DE); Michal Lacko, Zvolen (SK); Roman Látal, Brno (CZ); Petr Chrást, Brno (CZ)

(21) Appl. No.: 19/556,737

(22) Filed: Mar. 4, 2026

(30) Foreign Application Priority Data
Mar. 7, 2025 (GB) 2503314.3

(51) Int. Cl. H01J 49/04; H01J 3/40; H01J 49/00; H01J 49/10; H01J 49/24

(52) U.S. Cl. CPC H01J 49/0422; H01J 3/40; H01J 49/0031; H01J 49/049; H01J 49/10; H01J 49/24

(57) ABSTRACT

An ion source for an analytical instrument comprises an ionisation region, an ionisation device, a volume housing a reference compound, a heater configured to heat the reference compound, a transfer line connecting the volume to the ionisation region, and a carrier gas source configured to supply a carrier gas. The ion source is configured to generate reference ions by the heater heating the reference compound such that vaporised molecules and/or molecule clusters of the reference compound are produced in the volume, the carrier gas source supplying a carrier gas such that at least some of the vaporised reference compound molecules and/or molecule clusters are transported from the volume to the ionisation region via the transfer line, and at least some of the vaporised reference compound molecules and/or molecule clusters being ionised in the ionisation region so as to generate reference ions.

### CROSS REFERENCE TO RELATED APPLICATIONS

This application claims benefit of priority to United Kingdom Patent Application No. GB2503314.3, filed Mar. 7, 2025, the entire contents of this application being incorporated herein by reference.

### FIELD OF THE INVENTION

The present invention relates to the field of mass spectrometry, and particularly to apparatus for generating reference ions in a mass spectrometer.

### BACKGROUND

In quantitative gas chromatography (GC) and liquid chromatography (LC) applications, the doping of an internal standard to the sample being analysed by GC or LC is a well-established method for enhancing quantitative accuracy. However, such internal compounds are in most cases highly specific and expensive because they are unique for individual quantitative assay. For more accurate identification of an analyte (already separated by GC or LC), highly accurate mass determination provides advantages over classical GC or LC detectors, mainly via improved specificity achieved by identifying the exact mass-to-charge ratios of the compound of interest. To maximise the mass accuracy of such highly resolving analysis, an internal standard with known mass-to-charge ratio(s) is commonly used. This allows the mass scale to be calibrated prior to analysis of an analyte or can be introduced alongside the analyte in form of a lock-mass.

Existing apparatus for generating a known ionised compound from an internal standard varies between instruments in terms of compound type, delivery solution, and ionisation principle. In most cases, a separate ionisation of the calibrant compound (independently from the ionisation of the analyte) is used, which adds complexity and cost to the instrument.

For example, Orbitrap^{TM} Exploris^{TM} instruments use a dedicated internal calibrant source (ICS) positioned between the first and second vacuum chambers. Ion optical elements are used to inject generated calibrant ions into the ion path, ultimately leading to the mass detector.

Another approach utilises the injection of a neutral calibrant dissolved in a liquid solvent. The calibrant solution can be selectively sent to the ion source in place of the liquid flow from the LC line. This has the advantage that the calibrant ions follow the same ion path as the analyte ions. However, such a configuration can interrupt the flow of analyte and can be error prone, particularly if the container filled with the calibrant solution is not gas tight.

Bruker’s “Captive Nano-Spray Source” uses gas enrichment of a neutral compound for lock mass correction. However, the apparatus provides limited control over the calibrant signal intensity because the gas enrichment is provided by a calibrant solution doped onto a gas filter. Calibrant ions will always be present without control over their intensity which may cause suppression of the analyte signal, normally over several weeks until the gas filter (unpredictably) dries out. Refilling of the calibrant requires manual user interaction including removal of the gas filter.

It is believed that there remains scope for improvements to apparatus for generating ions.

### SUMMARY

A first aspect provides an ion source for an analytical instrument comprising:

an ionisation region;

a volume housing a reference compound;

a heater configured to heat the reference compound;

a transfer line connecting the volume to the ionisation region; and

a carrier gas source configured to supply a carrier gas;

wherein the ion source is configured to generate reference ions by:

the heater heating the reference compound such that vaporised molecules and/or molecule clusters of the reference compound are produced in the volume;

the carrier gas source supplying a carrier gas such that at least some of the vaporised reference compound molecules and/or molecule clusters are transported from the volume to the ionisation region via the transfer line; and

at least some of the vaporised reference compound molecules and/or molecule clusters being ionised in the ionisation region so as to generate reference ions.

Embodiments are directed to a simple and low-cost apparatus that provides well-controlled, on-demand generation of reference ions without the need for a second ion source. In embodiments, a volatile reference compound is heated in an oven so that the headspace within the oven volume is enriched with vaporised reference molecules and/or molecule clusters. The reference molecules and/or molecule clusters are transferred via a transfer line (which is independent to the gas lines commonly needed for the ionisation the analyte) to the ionisation region of the ion source and ionised therein by secondary ionisation.

As the reference ions are generated in the same ionisation region as the analyte ions, they will follow the same ion path as the analyte ions, and so they can be used to monitor the status of the entire instrument, including the status of (i) the ionisation, (ii) the ion transportation, (iii) the mass selection, and (iv) the mass detection. Furthermore, the intensity of the reference ions can be tightly controlled by controlling the heater and/or by controlling a flow of the carrier gas.

The ionisation region may be configured such that ions generated in the ionisation region can be transported to downstream stages of an analytical instrument via an inlet of the analytical instrument. The ion source may comprise an ionisation device configured to ionise analyte in the ionisation region so as to generate analyte ions. The ion source can generate analyte ions and reference ions at different times in the same ionisation region, and/or the ion source may be configured to simultaneously generate analyte ions and reference ions in the ionisation region. The analyte ions and reference ions can be transported (optionally together) from the ionisation region to the analytical instrument, i.e. via the same path.

The vaporised reference compound molecules and/or molecule clusters may be essentially electrically neutral gaseous vaporised calibrant reference compound molecules and/or molecule clusters. The ion source may be configured to ionise the vaporised reference compound molecules and/or molecule clusters by gas-phase interactions between: (i) the vaporised reference compound molecules and/or molecule clusters; and (ii) analyte ions and/or charged particles (such as charged molecules, molecule clusters or droplets) created by the ion source for generating analyte ions. The “charged particles created by the ion source for generating analyte ions” can be those charged particles created by the ion source when it is generating analyte ions from an analyte (e.g. charged analyte solution droplets in the case of an electrospray ionisation (ESI) ion source electrospraying an analyte solution), or can be charged particles created by the ion source when it is not generating analyte ions but is being operated in a manner that would generate analyte ions were an analyte present (e.g. charged solvent droplets in the case of an ESI ion source electrospraying a solvent that does not contain analyte). In ESI, independent of the presence of analyte, the electrospray process produces charged particles such as charged droplets having an excess of positive (or negative) charges when the spray needle is held at a positive (or negative) high voltage relative to the supplied cone voltage. It is the nature of the ESI process that the excess of positive or negative charge drives creation of clusters of charged particles that leads in turn to the highly efficient ionisation of solvent clusters and/or analyte molecules.

Thus, where the ion source is configured to generate analyte ions from an analyte solution, the ion source may be configured to ionise the vaporised reference compound molecules and/or molecule clusters by gas-phase interactions (e.g. charge transfer) between: (i) the vaporised reference compound molecules and/or molecule clusters; and (ii) analyte ions and/or charged particles (such as charged molecules, clusters, and/or droplets) created from the analyte solution.

The ionisation device may be configured to generate ions by atmospheric pressure chemical ionisation (APCI), electrospray ionisation (ESI), nano-ESI, liquid matrix assisted laser desorption ionisation (liquid MALDI), atmospheric pressure photo ionisation (APPI), direct analysis in real time (DART), atmospheric pressure laser ionisation (APLI), or any combination thereof. In particular embodiments, the ion source is configured to generate ions by electrospray ionisation (ESI).

In some embodiments, where the ion source is an electrospray ionisation (ESI) ion source comprising an electrospray ionisation (ESI) needle, an analyte source (such as a liquid chromatography (LC) separator) may be configured to supply analyte solution to the electrospray ionisation (ESI) needle, and the electrospray ionisation (ESI) needle may be configured to generate analyte ions in the ionisation region by electrospraying the analyte solution. The ion source may be configured to ionise reference compound molecules by gas-phase interactions between charged particles (e.g. droplets and/or ions) created by the electrospray ionisation (ESI) needle and the vaporised reference compound molecules and/or molecule clusters, i.e. by secondary electrospray ionisation (SESI).

The reference compound may be a volatile compound. The reference compound may be solid at room temperature and atmospheric pressure (e.g. at a temperature of about 20 °C (293 K, 68 °F) and an absolute pressure of about 1 atm (15 psi, 101 kPa). The reference compound may be solid when not heated by the heater.

The reference compound may be configured to produce positively charged reference ions under positive soft ionisation conditions or negatively charged reference ions under negative soft ionisation conditions. The reference compound may comprise at least one functional group that can be ionised under positive soft ionisation conditions and at least one further functional group that can be ionised under negative soft ionisation conditions.

The reference compound may comprise at least one proton acceptor group and at least one proton donor group. The at least one proton acceptor group may comprise an amino group or heterocyclic nitrogen and/or the at least one proton donor group may comprise a carboxylic acid group, or sulfonic acid group or hydroxy group. The at least one proton acceptor group may comprise a hetero aromatic functionality.

The reference compound may have at least one of (i) an acidic dissociation constant (pKa) of 2 to 6, such as around 4, (ii) a melting point of 80 to 300 ^{o}C, such as 80 to 160 ^{o}C, and (iii) a molar mass of 190 to 500 Da.

The reference compound may be selected from: amino acids and derivatives or metabolites of amino acids. The amino acids may be selected from phenylalanine, tyrosine, proline, arginine, histidine, and tryptophan. The derivatives or metabolites of amino acids may be selected from Tyrosine derivatives or metabolites and Tryptophan derivatives or metabolites. The derivatives or metabolites of amino acids may be selected from Tyrosine methyl ester, O-Methyl L-Tyrosine, 4-Methoxy-L-phenylalanine, 5-Hydroxy-L-tryptophan, Indole derivatives having acid groups, 3-Indole alkyl acids, 3-Indole propionic acid, 3-Indole acetic acid, 1-Indole propionic acid, 2-Methyl-3-indole acetic acid, 5-Hydroxy indole-3-acetic acid, 3-Indole acrylic acid, Indole-3-sulfonic acid, 3-Hydroxykynurenine, or 3-Hydroxyanthranilic acid.

The heater may be configured to heat the reference compound to a set temperature. The set temperature may be selected to cause the reference compound to generate vaporised (i.e. gaseous) reference compound molecules and/or molecule clusters (e.g. to sublimate) in the volume.

The ion source may further comprise a temperature sensor configured to measure the temperature of the volume and/or of the reference compound. The ion source may be configured to control the heater based on the temperature measured by the temperature sensor, i.e. so as to maintain the volume and/or the reference compound at the set temperature.

The carrier gas may be an inert gas such as nitrogen, i.e. so that the carrier gas is not ionised by the ion source. The carrier gas source may be configured to supply the carrier gas to the volume. The ion source may be configured such that the vaporised reference compound molecules and/or molecule clusters are transported from the volume to the ionisation region by a flow of the carrier gas from the volume to the ionisation region.

The inert gas may furthermore protect the reference compound (when it is in the volume housing the reference compound) against degradation, including but not limited to long-term degradation processes. For example, the inert gas may protect the reference compound (when it is in the volume housing the reference compound) from any one or more or each of: oxidation, moister and/or hydration (which may otherwise lead to undesired sample degradation pathway(s)).

The transfer line may be independent of (i.e. separate from) the ionisation device. Where the ion source comprises one or more gas lines configured to supply gas to the ionisation device for generation of analyte ions (such as a nebulising gas (or “sheath gas”) feed line and/or a heated auxiliary gas feed line, etc.), the transfer line may be independent of (i.e. separate from) each of the one or more gas lines (i.e. independent of the nebulising gas feed line, the heated auxiliary gas feed line, etc.) that supply gas to the ionisation device. The ion source may be configured such that a flow rate of the carrier gas can be controlled independently of (i.e. separately to) a flow rate of any gas (such as a nebulising gas (or “sheath gas”), heated auxiliary gas, etc.) provided to the ionisation device for generation of analyte ions.

The ion source may be configured to control generation of reference ions by controlling the heater and/or by controlling a flow of the carrier gas.

For example, the ion source may be configured to initiate (i.e. to turn on) generation of reference ions by increasing the temperature of and/or turning on the heater, i.e. such that vaporised reference compound molecules and/or molecule clusters are produced in the volume. The ion source may be configured to stop (i.e. to turn off) generation of reference ions by reducing the temperature of and/or turning off the heater, i.e. such that vaporised reference compound molecules and/or molecule clusters are not produced in the volume.

Additionally or alternatively, the ion source may be configured to initiate (i.e. to turn on) generation of reference ions by increasing or initiating a flow of the carrier gas from the volume to the ionisation region, i.e. such that vaporised reference compound molecules and/or molecule clusters are transported from the volume to the ionisation region via the transfer line. The ion source may be configured to stop (i.e. to turn off) generation of reference ions by reducing or stopping the flow of the carrier gas from the volume to the ionisation region, i.e. such that vaporised reference compound molecules and/or molecule clusters (where present) are not transported from the volume to the ionisation region via the transfer line.

The ion source may be configured to generate a target intensity of reference ions by adjusting a set temperature for the heater; and/or by adjusting a set flow level of the carrier gas. The target intensity can be set as desired. The target intensity can be set at a fixed value (e.g. during each experiment) or may be variable (e.g. may be varied during an experiment). For example, two (or more) different target intensities may be set during an LC run, e.g. (i) at times when no analytes are eluting from the column, and (ii) when analytes are eluting from the column. The target intensity can be set to avoid a too high reference ion signal, which might otherwise negatively interfere with the detection of analytes.

The ion source may further comprise a valve arranged between the carrier gas source and the volume. The valve may be arranged upstream of the volume (relative to the direction of the carrier gas flow), and so upstream of the reference compound. The valve may be configured to control the supply of carrier gas to the volume. The ion source may be configured to control generation of reference ions by controlling the valve. For example, the ion source may be configured to initiate (i.e. to turn on) generation of reference ions by opening the valve. The ion source may be configured to stop (i.e. to turn off) generation of reference ions by restricting or closing the valve.

The ion source may further comprise a filter configured to prevent solid particles of the reference compound being transported to the ionisation region, i.e. from the volume to the ionisation region via the transfer line. The filter may be arranged within the transfer line.

The reference compound may be provided within a cartridge, wherein the cartridge is removably installable (i.e. replaceable) in the ion source, e.g. wherein the cartridge is removably installable (replaceable) in the volume. The volume may be a chamber, such as a chamber of an oven.

Alternatively, the volume may be provided within a cartridge, and the cartridge may be removably installable (replaceable) in the ion source. Then, the filter may be arranged within the cartridge, i.e. may form part of the removably installable (replaceable) cartridge.

The cartridge may comprise a first filter and a second filter, wherein the reference compound may be provided within the cartridge between the first filter and the second filter. The ion source may be configured such that the carrier gas is passed from the carrier gas source to the transfer line via the first filter and the second filter.

The cartridge may be disposable.

According to another aspect, there is provided an analytical instrument comprising:

the ion source as described above; and

a fore vacuum chamber having an inlet;

wherein the analytical instrument is configured such that ions generated in the ionisation region of the ion source can be transported to the fore vacuum chamber via the inlet.

The ion source may further comprise a second valve between the volume housing the reference compound and the fore vacuum chamber. The second valve may be configured to control the supply of carrier gas to the fore vacuum chamber. The ion source may be configured to control generation of reference ions by controlling the second valve. For example, the ion source may be configured to stop (i.e. to turn off) generation of reference ions by opening the second valve, i.e. thereby allowing rapid depletion of the vaporised reference compound.

The instrument may comprise an analyser arranged downstream of the fore vacuum chamber. The analyser may be configured to analyse at least some of the reference ions and/or ions derived from the reference ions. For example, the reference ions can be fragmented or activated, e.g. by collision inducted dissociation (CID), and dissociate to a known daughter ion with known m/z, and these daughter ions may be analysed.

The analytical instrument may be a mass spectrometer. The analyser may be a mass analyser. The analyser may be arranged in a vacuum chamber of the instrument which is arranged downstream of the fore vacuum chamber. The analyser’s vacuum chamber may be maintained at a lower pressure than the fore vacuum chamber.

According to another aspect, there is provided a method of generating reference ions in an ion source for an analytical instrument, the ion source comprising:

an ionisation region;

a volume housing a reference compound;

a heater configured to heat the reference compound;

a transfer line connecting the volume to the ionisation region; and

a carrier gas source configured to supply a carrier gas;

the method comprising:

the heater heating the reference compound such that vaporised molecules and/or molecule clusters of the reference compound are produced in the volume;

the carrier gas source supplying a carrier gas such that at least some of the vaporised reference compound molecules and/or molecule clusters are transported from the volume to the ionisation region via the transfer line; and

at least some of the vaporised reference compound molecules and/or molecule clusters being ionised in the ionisation region so as to generate reference ions.

These aspects can, and in embodiments do, include any one or more or each of the optional features described above and elsewhere herein.

Thus, for example, the method may further comprise controlling the generation of reference ions by controlling the heater and/or by controlling a flow of the carrier gas.

The method may comprise initiating (i.e. turning on) generation of reference ions by increasing the temperature of and/or turning on the heater, i.e. such that vaporised molecules and/or molecule clusters of the reference compound are produced in the volume. The method may comprise stopping (i.e. turning off) generation of reference ions by reducing the temperature of and/or turning off the heater, i.e. such that vaporised molecules and/or molecule clusters of the reference compound are not produced in the volume.

Additionally or alternatively, the method may comprise initiating (i.e. turning on) generation of reference ions by increasing or initiating a flow of the carrier gas from the volume to the ionisation region, i.e. such that vaporised reference compound molecules and/or molecule clusters are transported from the volume to the ionisation region via the transfer line. The method may comprise stopping (i.e. turning off) generation of reference ions by reducing or stopping a flow of the carrier gas from the volume to the ionisation region, i.e. such that vaporised reference compound molecules and/or molecule clusters (where present) are not transported from the volume to the ionisation region via the transfer line.

The ion source may further comprise a valve arranged between the carrier gas source and the volume. The valve may be configured to control the supply of carrier gas to the volume. The method may comprise controlling generation of reference ions by controlling the valve. For example, the method may comprise initiating (i.e. turning on) generation of reference ions by opening the valve. The method may comprise stopping (i.e. turning off) generation of reference ions by restricting or closing the valve.

The ion source may further comprise a second valve between the volume housing the reference compound and the fore vacuum chamber. The second valve may be configured to control the supply of carrier gas to the fore vacuum chamber. The method may comprise controlling generation of reference ions by controlling the second valve. For example, the method may comprise stopping (i.e. turning off) generation of reference ions by opening the second valve, i.e. thereby allowing rapid depletion of the vaporised reference compound.

The method may comprise detecting, using the analyser, at least some of the reference ions or ions derived from the reference ions. The method may comprise calibrating the analytical instrument based on the detection and/or determining an operational state of the analytical instrument based on the detection. Thus, some embodiments provide an analytical instrument calibration or health check facilitated by well-controlled, on-demand generation of reference ions without the need for a second ion source. As the reference ions are generated in the same region as the analyte ions, they will follow the same ion path as the analyte ions, and so they may be used to monitor the status of the entire instrument, including the status of (i) the ionisation, (ii) the ion transportation, (iii) the mass selection, and (iv) the mass detection.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

### DESCRIPTION OF THE DRAWINGS

Various embodiments will now be described in more detail with reference to the accompanying Figures, in which:

FIG. 1 shows schematically a mass spectrometer in accordance with embodiments;

FIG. 2 shows schematically an ion source apparatus in accordance with embodiments;

FIG. 3 shows schematically detail of an ion source apparatus in accordance with embodiments;

FIG. 4 shows schematically detail of an ion source apparatus in accordance with embodiments;

FIG. 5A shows a representation of the time dependent response of reference signal produced by an apparatus configured in accordance with embodiments, FIG. 5B shows a mass spectrum without reference ions present, FIG. 5C shows a mass spectrum with positively charged reference compound ions, and FIG. 5D shows a mass spectrum with negatively charged reference compound ions;

FIG. 6A shows schematically part of an ion source apparatus in accordance with embodiments, and FIG. 6B shows schematically a reference compound cartridge for an ion source apparatus in accordance with embodiments; and

FIG. 7 shows schematically a reference compound cartridge for an ion source apparatus in accordance with embodiments.

### DETAILED DESCRIPTION

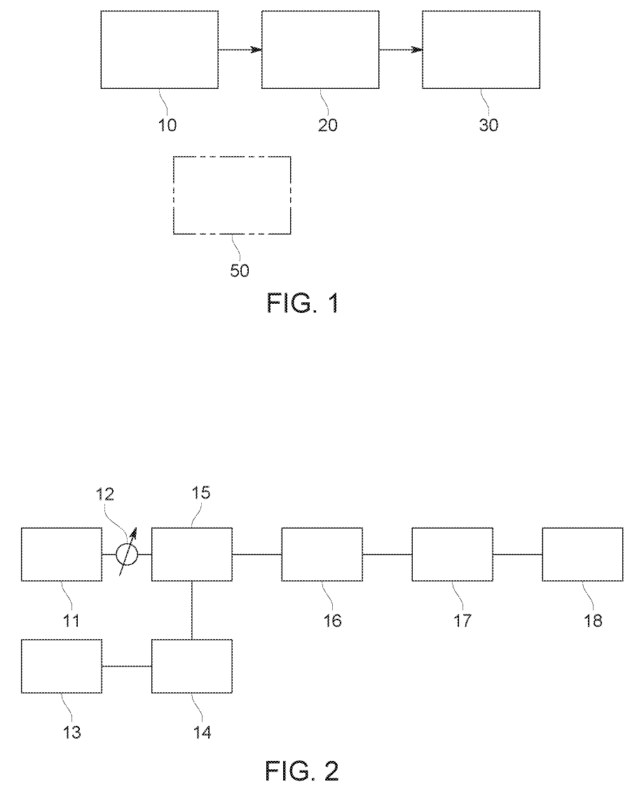

FIG. 1 illustrates schematically an analytical instrument, such as a mass spectrometer, that may be used in conjunction with the methods and apparatus described herein. As shown in FIG. 1, the instrument includes an ion source 10, a mass filter 20, and a mass analyser 30.

The ion source 10 is configured to generate ions from a sample. The ion source 10 can be any suitable ion source, such as a chemical ionisation (APCI) ion source, an electrospray ionisation (ESI) ion source, a liquid matrix assisted ionisation (liquid MALDI) ion source, an atmospheric pressure photo ionisation (APPI) ion source, or similar.

The ion source 10 may optionally be coupled to a separation device such as a liquid chromatography (LC) separation device or a capillary electrophoresis separation device (not shown), such that the sample which is ionised in the ion source 10 comes from the separation device.

The mass filter 20 is arranged downstream of the ion source 10 and is configured to receive ions from the ion source 10. The mass filter 20 is configured to filter the received ions according to their mass to charge ratio (m/z). The mass filter 20 may be configured such that received ions having m/z within an m/z transmission window (or “isolation window”) of the mass filter are onwardly transmitted by the mass filter, while received ions having m/z outside the m/z transmission window are attenuated by the mass filter, i.e. are not onwardly transmitted by the mass filter. The width and/or the centre m/z of the transmission window may be controllable (variable), e.g. by suitable control of RF and/or DC voltage(s) applied to electrodes of the mass filter 20. Thus, for example, the mass filter 20 may be operable in a transmission mode of operation, whereby most or all ions within a relatively wide m/z window are onwardly transmitted by the mass filter 20, and a filtering mode of operation, whereby only ions within a relatively narrow m/z window (centred at a desired m/z) are onwardly transmitted by the mass filter 20. The mass filter 20 can be any suitable type of mass filter, such as a quadrupole mass filter.

The mass analyser 30 is arranged downstream of the mass filter 20. The mass analyser 30 is configured to analyse received ions so as to determine their mass to charge ratio (m/z) and/or mass, i.e. to produce a mass spectrum of the ions. The mass analyser 30 can be any suitable type of mass analyser, such as an ion trap mass analyser, an electrostatic orbital trap mass analyser (such as an Orbitrap^{TM} FT mass analyser as made by Thermo Fisher Scientific), a time-of-flight (ToF) mass analyser such as a multi-reflecting time-of-flight (MR-ToF) mass analyser, or a quadrupole mass analyser. Numerous other types of mass analyser are possible.

It should be noted that FIG. 1 is merely schematic, and that the analytical instrument can, and in embodiments does, include any number of one or more additional components. For example, the instrument may include one or more ion transfer stage(s) arranged between any of the illustrated components, e.g. including an atmospheric pressure interface and/or one or more ion guides, lenses and/or other ion optical devices configured such that some or all of the ions can be transmitted appropriately through the instrument. The ion transfer stage(s) may include any suitable number and configuration of ion optical devices, for example optionally including one or more ion guides, lenses and/or other ion optical devices.

In some embodiments, the analytical instrument includes a collision or reaction cell for fragmenting or reacting ions, e.g. arranged downstream of the mass filter 20, and the ions analysed by the analyser 30 can be fragment or product ions produced by fragmenting or reacting parent ions generated by the ion source 10.

As also shown in FIG. 1, the instrument is under the control of a control unit 50, such as an appropriately programmed computer, which controls the operation of various components of the instrument including the analyser 30. The control unit 50 may also receive and process data from various components including the detector(s) in accordance with embodiments described herein.

Embodiments provide a method and apparatus for generating reference ions in the instrument ion source 10. Well controlled generation of reference ions can be used to calibrate the instrument and/or to monitor the status of the instrument, including the status of (i) the ionisation, (ii) the ion transportation, (iii) the mass selection, as well as (iv) the mass detection. Embodiments provide a simple and low-cost apparatus for the controlled generation of reference ions (such as calibrant ions) without the need for a second ion source. The apparatus is relatively simple and provides “on demand” reference ions via the introduction and ionisation of a volatile reference (at atmosphere).

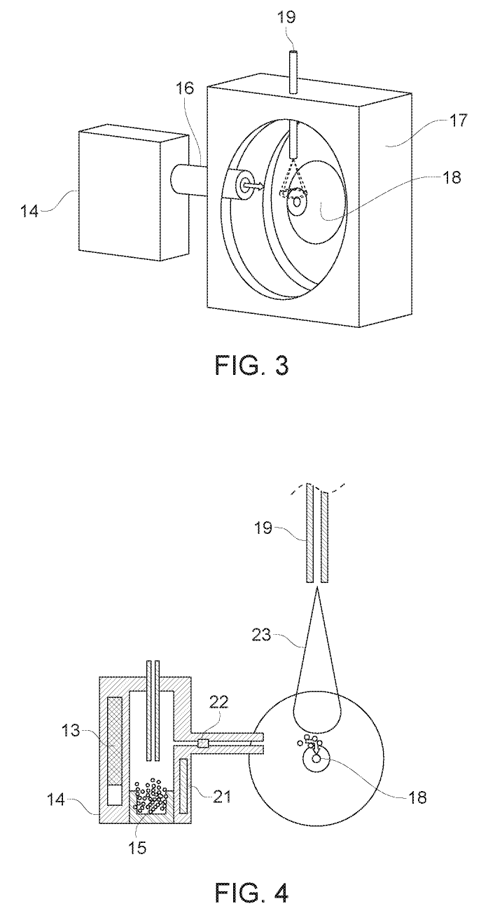

FIG. 2 illustrates schematical a gas enrichment apparatus according to embodiments. As shown in FIG. 2, the apparatus comprises an inert carrier gas source 11 coupled to a pressure-controlled valve 12 which together provide a controlled gas flow of inert carrier gas. A controlled heater supply 13 is connected to an oven 14, which stores a volatile compound 15. The temperature of the oven is set so that the compound does not degrade and is stable at the set temperature. A transfer line 16 connects the oven 14 to an ionisation region 17 of the analytical instrument. The transfer line may be indirectly heated by the oven 14. Downstream of the ionisation region 17 is the atmospheric pressure inlet 18 of the mass spectrometer.

The compound 15 is stored in the oven 14 which is maintained at a constant temperature by the heater 13. The compound 15 is a volatile, solid compound. At the set temperature of the heater 13 the compound 15 sublimates into the gas phase, enriching the headspace within the oven volume 14. Once the inert carrier gas is actively injected into the oven 14, the compound enriched vaporised (i.e. gaseous) head space is transferred via the transfer line 16 towards the ionisation volume 17.

The ionisation of the vaporised compound occurs in the ionisation volume 17 of the ion source via secondary electrospray ionisation (SESI). The SESI method relies on the gas-phase interaction between charged particles created by electrospray ionisation (ESI) and neutral vaporised sample molecules (see, e.g., Anal. Chem. 2000, 72, 396-403). The primary ions, generated by the ion source, react with the neutral vaporised compound molecules within the ion source's volume 17. The ionised volatile compound then enters the mass spectrometer simultaneously with the primary ions generated by electrospray.

The vaporised compound may be ionised to produce negatively or positively charged reference ions depending on the set polarity of the ion source. The ion source produces positive (or negative) ions when the spray needle is held at a positive (or negative) high voltage relative to the cone voltage.

The volatility of the compound is controlled by the oven temperature. The carrier gas flow determines if the compound either remains inside the oven or is transferred into the ionisation volume.

FIG. 3 shows detail of an embodiment of an electrospray ion source, including the apparatus for transferring volatile compound by the inert carrier gas. A compound oven 14 includes the solid compound and is connected to a compound transfer line 16. A high voltage applied to the electrospray needle 19 and the solvent flowing through the needle generates a positively or negatively charged electrospray ion plume 23 in the electrospray ion source chamber 17 which includes the mass spectrometer inlet 18. The carrier gas enriched by the vapor of the volatile compound enters the ionisation volume 17 of the electrospray source at atmosphere pressure or near atmospheric pressure allowing a simple, reliable and low-cost design.

FIG. 4 illustrates further detail of an embodiment of the apparatus. FIG. 4 again shows the oven 14 housing the reference compound 15. A heater 13, in cooperation with a temperature sensor 21, heats the reference compound 15 to a set temperature. An electrospray plume 23 is produced close to the atmospheric inlet 18 to the mass spectrometer by an electrospray needle 19. The nozzle at the end of the transfer line is targeted towards the atmospheric inlet 18 to the mass spectrometer. A filter 22 is provided within the transfer line to prevent solid particles of the reference compound from entering the ionisation region.

As illustrated in FIGS. 3 and 4, the transfer line 16 is separate from and independent of the electrospray needle 19. FIGS. 3 and 4 show the transfer line 16 being arranged at an angle of approximately 90° relative to the electrospray needle 19, but other angles and other arrangements would be possible, as long as the transfer line 16 is separate from and independent of the electrospray device 19. The independent transfer line 16 allows reference compound molecules and/or molecule clusters to be introduced into the ionisation region 17 without affecting the operation of the electrospray device 19. For example, the ion source be configured such that the carrier gas does not have any significant effect on the ion plume 23 produced by the needle 19.

Although not shown in FIGS. 3 and 4, the electrospray needle 19 is typically surrounded by a nebulising gas (or “sheath gas”) supply tube. A nebulising gas supplied from this tube is used to create the electrospray plume 23, e.g. by promoting droplet formation and/or droplet desolvation of the liquid analyte that is sprayed from the spray needle 19. This supply tube is in turn fed with a nebulising gas via a gas feed line. The carrier gas transfer line 16 is separate from and independent of this nebulising gas feed line (and the nebulising gas supply tube).

Similarly, in some cases, an auxiliary heated gas may additionally be provided and, e.g., used to assist with droplet desolvation. Such heated gas is commonly used when relatively high liquid sample flow rates are desired. This auxiliary gas may be supplied via a gas feed line, where the carrier gas transfer line 16 is again separate from and independent of this gas feed line.

In general, the transfer line 16 is configured such that the reference compound molecules and/or molecule clusters are introduced into the ionisation chamber 17 via a transfer line that is separate from and independent to the gas line(s) associated with the ionisation device such as those commonly needed for ionisation of the analyte. This arrangement has various benefits, particularly in terms of controllability.

As will be understood by persons skilled in the art, various parameters of the ionisation device must be carefully controlled to achieve efficient analyte ionisation. In some arrangements, these parameters may be carefully adjusted by a user, e.g. depending on the analyte in question and/or the experimental conditions, etc. For example, the flow rate of the nebulising gas (and/or the auxiliary gas) should be carefully controlled to achieve suitable droplet formation and/or droplet desolvation of the liquid analyte as it is sprayed from the spray needle 19. Similarly, various parameters of the carrier gas, including for example its flow rate, may be carefully controlled to control the production of reference ions.

By configuring the transfer line 16 to be separate from and independent of the nebulising gas feed line (and any other gas lines needed for ionisation of the analyte), the relevant parameters of the carrier gas (e.g. including its flow rate) can be controlled independently of the relevant parameters for ionisation of the analyte (e.g. including the nebulising gas flow rate, the auxiliary gas, etc.). This ensures that both processes (generation of analyte ions by ESI and generation of refence ions by secondary ESI) can be independently controlled and optimised. In particular, turning on/off of the reference ions by control of the carrier gas flow rate does not substantially affect the ability of the ionisation device 19 to generate analyte ions.

In addition, this design means that the apparatus can be retrofitted to existing ion sources without affecting the operation of and/or tuning of the source.

As described above with respect to FIG. 2, the carrier gas is controlled by a valve 12 which is arranged upstream of the oven 14 (and upstream of the reference compound 15). This means that the valve 12 is configured to regulate only the carrier gas (which may typically be an inert gas such as nitrogen) and does not encounter the reference compound or the vaporised reference compound molecules. This in turn means that the valve need only be suitable for regulating the carrier gas (and not for regulating the compound enriched carrier gas) so that a lower cost component can be used and/or so that the lifetime over which it can be used for accurate control of the carrier gas flow rate can be increased.

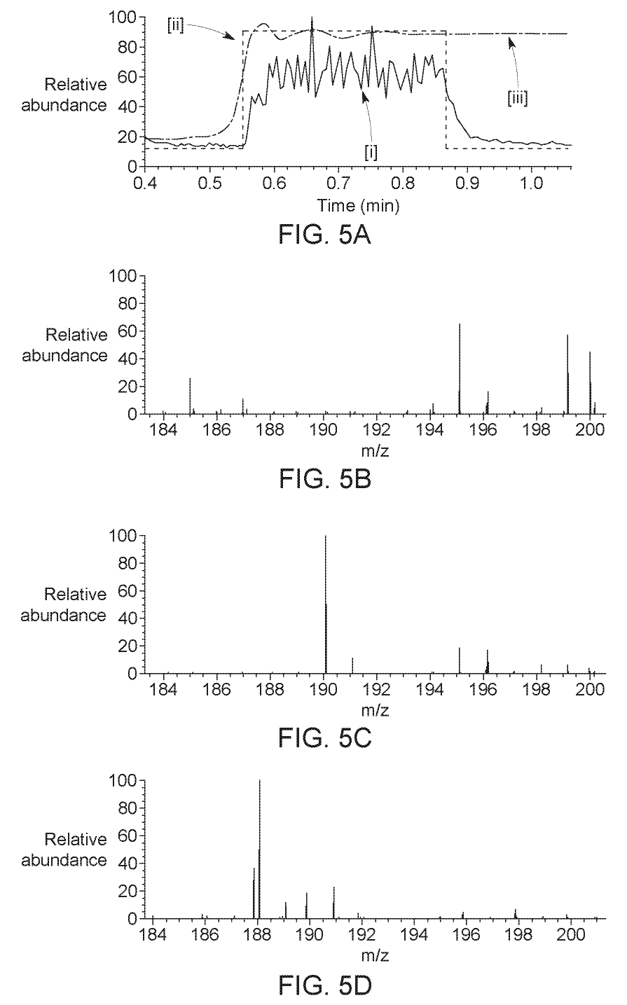

The design according to embodiments was tested using several suitable candidates for the reference compound. An example set of results, which illustrates the working principle of the apparatus, is shown in FIG. 5. This example used crystalline 3-Indol propionic acid.

FIG. 5A shows a representation of the time dependent response of the reference signal [i] triggered by turning the carrier gas on/off [ii] (dotted line) when the oven is heated [iii] (light dotted line). FIG. 5B shows a mass spectrum without the internal reference present, e.g. with the carrier gas flow off and the temperature setpoint low. FIG. 5C shows a mass spectrum with positively charged reference ions present, and FIG. 5D shows a mass spectrum with negatively charged reference ions present.

It can be seen from FIG. 5 that once heat and the gas flow is applied, the reference compound flows into the electrospray source, producing ions with m/z 190 and m/z 188 for positive and negative electrospray polarities, respectively. Once the gas flow is restricted, the abundance of compound ions in the spectrum diminishes.

The reference compound can be selected as desired. Particular embodiments make use of a neutral organic solid compound with a high vapor pressure, which sublimates into the gas phase to be ionised by secondary ionisation by the ion source. The neutral compound may have the following properties:

The compound may be amphoteric: it can react both as an acid and a base, producing either positively or negatively charged reference ions from a single chemical compound.

The chemical structure of the compound can include at least two functional groups:

At least one functional group of the neutral compound may be preferentially ionised under positive soft ionisation conditions (e.g. positive soft ESI conditions) to produce a positively charged ion with a known m/z value. An example of such a functional group that may be preferentially ionised under positive soft ionisation conditions is a proton acceptor group. Examples of suitable proton acceptor groups are an amine group, which may be a primary, secondary or tertiary amine group, such as a terminal amine group, and/or a heterocyclic or heteroaromatic nitrogen atom. The presence of the proton acceptor group may render the compound basic, e.g. slightly basic. The at least one proton acceptor group comprising a hetero aromatic functionality may comprise enhanced proton affinity due to the presence of a hetero atom providing higher electron density.

At least one functional group of the neutral compound may be preferentially ionised under negative soft ionisation conditions (e.g. negative soft ESI conditions) to produce a negatively charge ion with a known m/z value. An example of such a functional group that may be preferentially ionised under negative soft ionisation conditions is a proton donor group, such as a carboxyl group, or sulfonic acid group, or hydroxy group. An example of such a functional group that may be preferentially ionised under negative soft ionisation conditions is a proton donor group, such as a carboxyl group, or sulfonic acid group, or hydroxy group. The presence of the proton donor group may render the compound acidic, e.g. slightly acidic. Some proton donor functionality can be stabilized by resonance such as in a phenol functionality. This is because the phenoxide ion (C₆H₅O⁻), which forms when phenol loses a proton (H⁺), is stabilized by resonance. This stabilization makes it easier for phenol to donate a proton, thus acting as a stronger acid compared to aliphatic alcohols.

The compound may be a non-volatile solid with a low vapor pressure (e.g. < 20 Pa) at room temperature and atmospheric pressure. The compound may undergo sublimation when heated, i.e. transition directly from solid to gas phase.

The melting point of the compound may be between 80 °C and 300°C, such as between 80 °C and 160 °C, or between 80 °C and 110 °C. The lower limit of the melting point in the forementioned ranges may be higher than 80 °C, such as 100 °C.

The compound may be chemically stable, such that it will not react or decompose at room temperature as well as at elevated temperatures, e.g. up to 150 °C.

The acidity / basicity of the functional groups may be such that ions are generated under a wide range of solvent compositions and pH values commonly used in liquid chromatography-mass spectrometry (LC-MS). The acidic dissociation constant pKa is a quantitative measure of the strength of an acid in solution; it is the equilibrium constant for the dissociation of the acid into a solvated proton and the corresponding base. In embodiments, the reference compound is a neutral compound for ionisation with weak acidic properties. If the pKa of the compound is too low (e.g. pKa < 1) then the protonation probability is expected to be very low and the ionisation efficiency in the positive polarity mode is expected to be low and the corresponding reference ion intensity too weak. If the pKa of the neutral compound is too high (e.g. pKa >7), then the dissociation of the compound can be expected to be too low and the deprotonation of the neutral compound in the negative polarity mode of the electrospray will be very inefficient. In embodiments, the reference compound has a pKa value in a range of 2-6, for example a pKa of 4 or around 4.

The acidic functionality can be a carboxylic acid group optionally with varying alkyl chain length, or can be a sulfonic acid group optionally with varying alkyl chain length, or can be a phenol group.

The compound may be soluble in both water and organic solvents. However, the compound is not provided as a solution in the analytical instrument, for example in the volume housing the compound, but rather as a solid that can be vaporised by heating.

The compound may be provided as a pure substance in the solid state. Thus, no other compounds are introduced into the ion source when the solid compound is heated. In some embodiments, a solid mixture consisting essentially of two or more compounds may be used.

The compound should typically not be a hazardous, toxic, carcinogenic compound or a compound otherwise persistent in the environment.

The compound should typically be naturally occurring.

In some embodiments, to mass selectively separate the neutral compound from any analytes of the intended application, one or more atoms of the compound can be isotopically enriched, such as deuterated, and/or the compound may carry a substituent such as one or more halogen atoms, for example fluorine.

The compound may be relatively cheap and readily available.

The compound may have a molar mass in the range 190 to 500 Da. The compound may provide one major mass peak both in positive and negative ionisation modes, e.g. in the mass range between 190-500 Th, and more typically between 150 and 250 Th.

The feasibility of a method using secondary ionisation was tested for several volatile and solid compounds having the above-described chemical properties. The compounds which delivered the best results were:

Amino acids and derivatives or metabolites of amino acids. The derivatives may be esters of the amino acids.

In particular, the following amino acids: phenylalanine, tyrosine, proline, arginine, histidine, tryptophan.

In particular, Tyrosine derivatives, such as Tyrosine methyl ester or 4-Methoxy-L-phenylalanine or O-Methyl L-Tyrosine, or Methyl L-tyrosinate.

In particular, Tryptophan derivatives such as 3-Indole alkyl acids.

In particular 5-Hydroxy-L-tryptophan.

In particular tryptophan metabolites such as 3-Hydroxykynurenine, 3-Hydroxyanthranilic acid.

In particular, Indole derivatives having acid groups, such as carboxyl or sulfonic acid functional groups.

In particular 3-Indole alkyl acids such as 3-Indole propionic acid or 3-Indole acetic acid.

In particular 1-Indole propionic acid.

In particular 2-Methyl indole 3 acetic acid, 5-Hydroxy indole-3-acetic acid, or 3-Indole acrylic acid.

In particular Indole-3-sulfonic acid.

In some embodiments, the compound may be a phytohormone, or a product of gut microbiota metabolism.

Other compounds of use may include: 4-Hydroxyphenylacetic acid, 3,4-Dihydroxyphenylacetic acid, Homovanillic acid, 4-Hydroxyphenylpyruvic acid, Cholic acid and cholate derivatives thereof, or Glycyrrhizin.

It will be appreciated that embodiments provide a simple mechanism for controllably providing reference ions by introducing reference compound molecules into the ionisation region of a mass spectrometer. A fast response rate and high reference ion intensity is achieved through control of two variables, namely (i) the carrier gas flow, and (ii) the oven heater temperature. As the gas enrichment apparatus is very compact, it can be positioned very close to the ionisation region, thus reducing the compound response time. Reference ions can be introduced as a lock mass at any time, e.g. during an LC run. The independent reference carrier gas line allows the reference ions to be turned on and off without reconfiguring the source.

The apparatus is robust and requires minimal manufacturing cost. The demands of electrotechnical complexity include only temperature control of the oven and control of the carrier gas supply, which can be positioned anywhere in the system. No reconfiguration of the ion source is required. The apparatus provides easy access to its integral parts thereby facilitating ease of serviceability and prolonging the lifetime of the apparatus. The apparatus can be cleaned with a simple bakeout, which is a contact-free and simple cleaning method. The simplicity of the apparatus allows it to be very compact, so that it can be arranged directly adjacent to, connected to, and easily removed from the ion source of a mass spectrometer. The resulting implementation removes any need for permanent modifications to vacuum distribution parts or sample lines of the instrument while being seamlessly integrated to the ion introduction system.

The compound can be selected to have low volatility and to be stable at room temperature for prolonged periods, which further decreases costs and serviceability demands. The carrier gas can be forcefully blown over a large volume of compound crystals, ensuring high compound vapor saturation, thus reducing the oven operation temperature and reducing compound consumption and ultimately improving system robustness.

The solid compound may be not dissolvable in solution and may thereby be better protected against sample decomposition. The inert gas, such as nitrogen, can protect the volatile compound against degradation such as moisturising or oxidation (which might otherwise occur if air were used as a carrier gas).

Another benefit of the herein-described solvent-less reference delivery approach is that is avoids the need for sample solvent handling. This addresses the following problems with solvent-based approaches:

calibrant solvent bottles and/or the connecting lines are prone to leaks (particularly if the sample is stored in a vial for long times);

solvent can evaporate and the concentration of the calibrant can change over time, resulting in long time dependent changes of the signal response;

decomposition of the dissolved calibrant compound is higher compared to solid compounds; solid compounds are protected from degradation;

solvents such as organic solvents (e.g. acetonitrile, methanol or isopropanol) will wash out any unwanted compounds such as softeners from the sample reservoir, which necessitates either the selection of expensive solvent vials or frequent exchange of the sample;

common ESI solvents include acidic components which support the ESI process; acids or basics can catalytically speed up decomposition processes or organic processes such as beta elimination; in embodiments, the acidic (or basic) condition of the ESI solvent is separated from the reference compound reservoir.

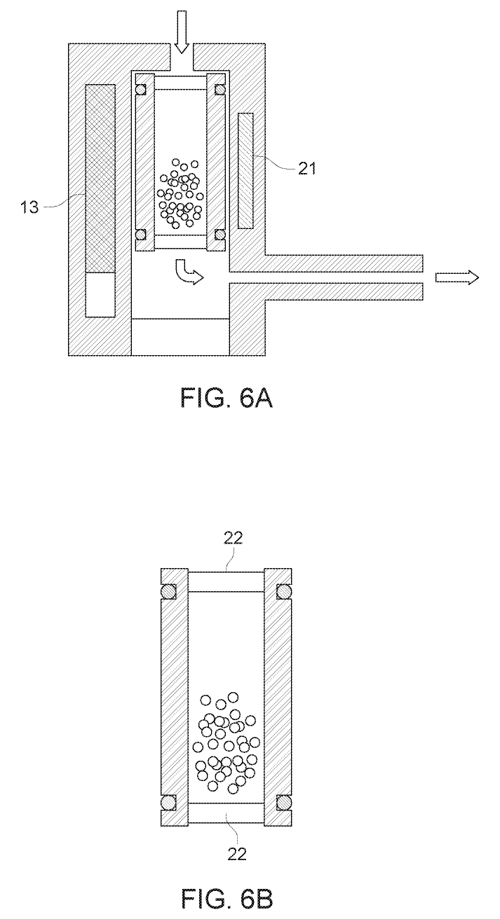

In some embodiments, the apparatus uses preconfigured and low-cost disposable reference compound cartridges to minimise user error. Then, only minor user interaction is required, mainly for replacement of the reference cartridge, e.g. in iterations of several months. The formulation of the reference compound inside a disposable cartridge ensures safe transportation of such a consumable. An example of such a cartridge is shown in FIGS. 6A-B. FIG. 6B shows a reference cartridge filled with the reference, while FIG. 6A shows the cartridge inserted into the gas enrichment apparatus.

As illustrated by FIGS. 6A-B, the cartridge is filled with the reference compound and sealed with porous end caps 22, enabling efficient vapor saturation directly in line with the carrier gas flow without contamination of the gas line with any ejected solid material. The material of the porous end caps 22 can be selected so as not to introduce any contamination into the mass spectrometer, and the porosity of the filters may be selected to achieve both relatively unrestricted gas flow and efficient encapsulation of the volume of solid reference compound.

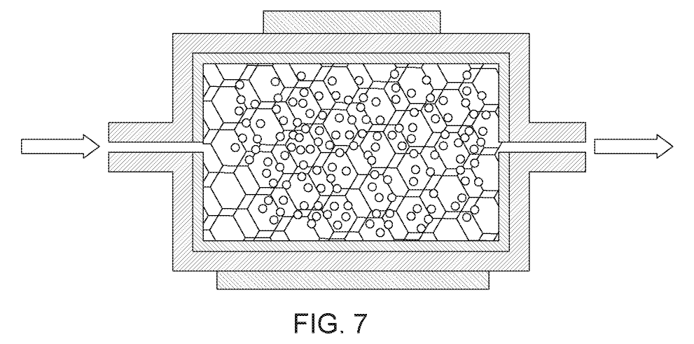

Alternatively, a reference-bearing cartridge may be inserted in-line with the carrier gas supply. FIG. 7 shows such an in-line reference-bearing cartridge, containing a porous mesh saturated with the reference compound. As shown in FIG. 7, the cartridge comprises a porous mesh with a very high surface area, saturated with the reference compound. This can further increase the efficiency of vapor saturation and compound transfer and can thus prolong the operational lifetime of the cartridge.

Although particular embodiments have been described above, various alternatives are possible.

For example, in some embodiments, the flow of the carrier gas may not be precisely controlled, so that the concentration of the vaporised reference doped into the ionisation plume is not precisely controlled. Similarly, in some embodiments the oven temperature may not be precisely controlled, so that the temperature dependent vapor pressure is not precisely controlled.

In some embodiments, the compound may not be solid at the intended low temperature such as room temperature

Particular embodiments have been described above in terms of electrospray ionisation (ESI). However, in general the principles described herein can be applied to other fields outside of soft ionisation. This includes, for example, both atmospheric pressure and low-pressure ionisation systems producing primary ions capable of reacting with the reference compound via secondary ionisation. Suitable ionisation techniques include, for example, atmospheric pressure chemical ionisation (APCI), electrospray ionisation (ESI), nano-ESI, liquid matrix assisted laser desorption ionisation (liquid MALDI), atmospheric pressure photo ionisation (APPI), direct analysis in real time (DART), atmospheric pressure laser ionisation (APLI), similar methods, and combinations thereof.

Although the present invention has been described with reference to various embodiments, it will be understood that various changes may be made without departing from the scope of the invention as set out in the accompanying claims.

1. An ion source for an analytical instrument comprising:
an ionisation region;
an ionisation device configured to ionise analyte in the ionisation region so as to generate analyte ions;
a volume housing a reference compound;
a heater configured to heat the reference compound;
a transfer line that is independent of the ionisation device and that connects the volume to the ionisation region; and
a carrier gas source configured to supply a carrier gas;
wherein the ion source is configured to generate reference ions by:
the heater heating the reference compound such that vaporised molecules and/or molecule clusters of the reference compound are produced in the volume;
the carrier gas source supplying a carrier gas such that at least some of the vaporised reference compound molecules and/or molecule clusters are transported from the volume to the ionisation region via the transfer line; and
at least some of the vaporised reference compound molecules and/or molecule clusters being ionised in the ionisation region so as to generate reference ions.

2. The ion source of claim 1, wherein the ion source is configured to simultaneously generate analyte ions and reference ions in the ionisation region.

3. The ion source of claim 1, wherein the ion source is configured to ionise the vaporised reference compound molecules and/or molecule clusters by gas-phase interactions between: (i) the vaporised reference compound molecules and/or molecule clusters; and (ii) analyte ions and/or charged particles created by the ion source for generating analyte ions.

4. The ion source of claim 1, wherein the ionisation device is configured to generate analyte ions by atmospheric pressure chemical ionisation (APCI), electrospray ionisation (ESI), nano-ESI, liquid matrix assisted laser desorption ionisation (liquid MALDI), atmospheric pressure photo ionisation (APPI), direct analysis in real time (DART), atmospheric pressure laser ionisation (APLI), or a combination thereof.

5. The ion source of claim 1, wherein the reference compound is solid at room temperature and atmospheric pressure.

6. The ion source of claim 1, wherein the heater is configured to heat the reference compound to a set temperature, wherein the set temperature is selected to cause the reference compound to generate vaporised reference compound molecules and/or molecule clusters.

7. The ion source of claim 6, further comprising a temperature sensor configured to measure the temperature of the volume and/or of the reference compound, wherein the ion source is configured to control the heater based on the temperature measured by the temperature sensor.

8. The ion source of claim 1, further comprising one or more gas lines configured to supply gas to the ionisation device for generation of analyte ions, wherein the transfer line is independent of the one or more gas lines.

9. The ion source of claim 1, wherein a flow rate of the carrier gas can be controlled independently of a flow rate of gas provided to the ionisation device for generation of analyte ions.

10. The ion source of claim 1, wherein the ion source is configured to control generation of reference ions by controlling the heater and/or by controlling a flow rate of the carrier gas.

11. The ion source of claim 1, wherein:
the ion source is configured to initiate generation of reference ions by increasing the temperature of and/or turning on the heater; and/or
the ion source is configured to stop generation of reference ions by reducing the temperature of and/or turning off the heater; and/or
the ion source is configured to generate a target intensity of reference ions by adjusting a set temperature for the heater.

12. The ion source of claim 1, wherein:
the ion source is configured to initiate generation of reference ions by increasing or initiating a flow of the carrier gas from the volume to the ionisation region; and/or
the ion source is configured to stop generation of reference ions by reducing or stopping a flow of the carrier gas from the volume to the ionisation region; and/or
the ion source is configured to generate a target intensity of reference ions by adjusting a set flow level of the carrier gas.

13. The ion source of claim 1, further comprising a valve arranged between the carrier gas source and the volume, wherein the valve is configured to control the supply of carrier gas to the volume, and wherein the ion source is configured to control generation of reference ions by controlling the valve.

14. The ion source of claim 1, further comprising a filter configured to prevent solid particles of the reference compound being transported to the ionisation region.

15. The ion source of claim 14, wherein the filter is arranged within the transfer line.

16. The ion source of claim 1, wherein:
the reference compound is provided within a cartridge, and wherein the cartridge is removably installable in the volume; or
wherein the volume is provided within a cartridge, and wherein the cartridge is removably installable in the ion source.

17. The ion source of claim 16, further comprising a filter configured to prevent solid particles of the reference compound being transported to the ionisation region, wherein the filter is arranged within the cartridge.

18. The ion source of claim 17, wherein the cartridge comprises a first filter and a second filter, wherein the reference compound is provided within the cartridge between the first filter and the second filter, and wherein the ion source is configured such that the carrier gas is passed from the carrier gas source to the transfer line via the first filter and the second filter.

19. An analytical instrument comprising:
the ion source of claim 1; and
a fore vacuum chamber having an inlet;
wherein the analytical instrument is configured such that ions generated in the ionisation region of the ion source can be transported to the fore vacuum chamber via the inlet.

20. A method of generating reference ions in an ion source for an analytical instrument, the ion source comprising:
an ionisation region;
an ionisation device configured to ionise analyte in the ionisation region so as to generate analyte ions;
a volume housing a reference compound;
a heater configured to heat the reference compound;
a transfer line that is independent of the ionisation device and that connects the volume to the ionisation region; and
a carrier gas source configured to supply a carrier gas;
the method comprising:
the heater heating the reference compound such that vaporised molecules and/or molecule clusters of the reference compound are produced in the volume;
the carrier gas source supplying a carrier gas such that at least some of the vaporised reference compound molecules and/or molecule clusters are transported from the volume to the ionisation region via the transfer line; and
at least some of the vaporised reference compound molecules and/or molecule clusters being ionised in the ionisation region so as to generate reference ions.
